(19) United States
(12) Patent Application Publication
(10) Pub. No.: US 2015/0193738 A1
(43) Pub. Date: Jul. 9, 2015

(54) Calendar resource selection utility

(71) Applicants: Paul Hangas, San Jose, CA (US); Scott Putterman, Cupertino, CA (US); Bruce Clift, Scotts Valley, CA (US); James Fulker, Palo Alto, CA (US)

(72) Inventors: Paul Hangas, San Jose, CA (US); Scott Putterman, Cupertino, CA (US); Bruce Clift, Scotts Valley, CA (US); James Fulker, Palo Alto, CA (US)

(73) Assignee: Good Technology, Inc.

(21) Appl. No.: 11/642,364

(22) Filed: Dec. 18, 2006

(51) Int. Cl. G06Q 10/10; G06Q 10/06

(52) U.S. Cl. CPC G06Q 10/1095; G06Q 10/06

(57) ABSTRACT

A method and apparatus for a calendar resource selection utility are disclosed. The method includes: maintaining a catalog of resources to be used for a meeting scheduled via a meeting setup interface of a scheduling application, the resources including at least one of locations for the meeting and inventory to be reserved for the meeting; receiving, via the meeting setup interface, a request for available resources during a time of the meeting; providing, via the meeting setup interface, a list of the resources from the catalog of resources that are available at the time; and scheduling one or more of the resources that are selected via the meeting setup interface as occupied during the time of the meeting. Other embodiments are also disclosed.

### FIELD OF THE INVENTION

This invention relates generally to the field of scheduling applications for computing devices. More particularly, the invention relates to a calendar resource selection utility.

### BACKGROUND

A variety of wireless data processing devices have been introduced over the past several years. These include wireless personal digital assistants (“PDAs”) such as the Palm® VIIx handheld, cellular phones equipped with data processing capabilities (e.g., those which include wireless application protocol (“WAP”) support), and, more recently, wireless messaging devices such as the Blackberry™ wireless pager developed by Research In Motion (“RIM”)™.

In implementing features into a wireless messaging device, many times the features are based on a current implementation of state of the art applications. However, in many cases, improvements can be made over the current state of the art implementation.

In the case of adding functionality to schedule and edit meetings from a wireless messaging device, this functionality may be based on current scheduling applications already in place in various electronic computing devices. Current scheduling applications allow for checking the availability of invitees and resources (typically meeting rooms) from the device. Yet, when adding these features to a wireless messaging device, there are functionalities missing from the scheduling application that may be improved in the application on the wireless messaging device.

For instance, to reserve a location in current scheduling applications, the location is added in the same manner that any of the invitees are invited. The location is typed in as a possible invitee and it is at this point that the availability of the location may be determined. If the location is not available, then another location is added to the list of invitees to determine its availability. A user must remember potential locations to be entered into the meeting request. There is no mechanism to provide a customized list of resources to choose from.

In addition, if a location is found and determined to be available, then this location must be marked as a ‘resource’ instead of as a default invitee to reserve the location for the meeting. If the location is not marked as a resource, then the invitee runs the risk of another meeting being scheduled at the location at the same date and time.

As a result, the current approach of scheduling applications to reserve a location for a meeting can be a slow and cumbersome process. There may be many locations to remember and sift through before an available location is found. On top of that, if the location is not marked as a resource, the risk is run that a location may be lost because it can still be reserved for another meeting. Therefore, a utility that addresses the limitations of the current scheduling applications, particularly in a wireless messaging device, would be beneficial.

### BRIEF DESCRIPTION OF THE DRAWINGS

A better understanding of the present invention can be obtained from the following detailed description in conjunction with the following drawings, in which:

FIG. 1 is a flow diagram of a method according to one embodiment of the invention;

FIG. 2 is a screenshot of an embodiment of the invention;

FIG. 3 is another screenshot of an embodiment of the invention;

FIG. 4 illustrates one embodiment of a computer system; and

FIG. 5 illustrates one embodiment of a network.

### DETAILED DESCRIPTION

According to one embodiment, a calendar resource selection utility is disclosed. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Throughout the following description, reference may be made to embodiments of the invention being located and performed in a wireless messaging device. However, one skilled in the art will appreciate that embodiments of the invention may be located and operate on any general computing device and are not necessarily limited to a wireless messaging device.

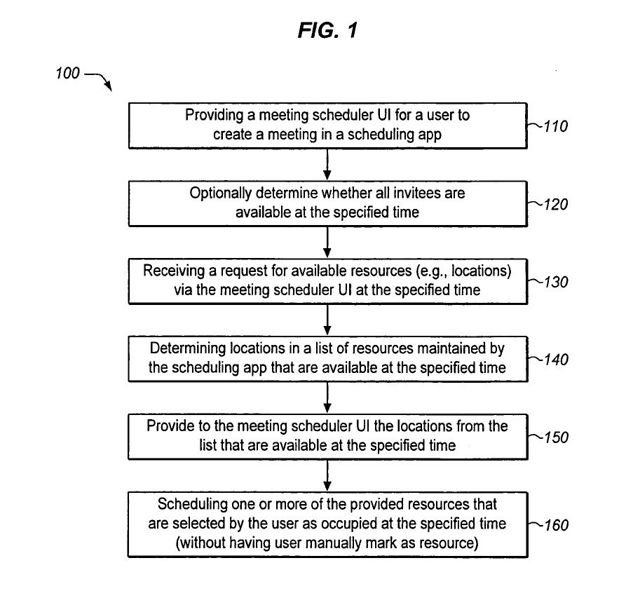

FIG. 1 is a flow diagram for a method of one embodiment of the calendar resource selection utility. Process 100 is a method for calendar resource selection in a scheduling application. The scheduling application may be located and operate on any general computing device. However, in some embodiments, process 100 is performed by a scheduling application on a wireless messaging device. For instance, embodiments may utilize a wireless messaging device having a Microsoft Outlook™ scheduling application that references a Microsoft Exchange™ server. Other embodiments may utilize a wireless messaging device having a Lotus Notes™ scheduling application that references a Lotus Domino™ server. One skilled in the art will appreciate that various scheduling applications and servers may be utilized.

Process 100 begins at processing block 110 where a meeting scheduler user interface (UI) is provided by a scheduling application to a user in order for the user to create a meeting event in the scheduling application. Then, at processing block 120, the scheduling application may optionally determine whether all indicated invitees are available at a time specified by the user in the meeting scheduler UI. In some embodiments, the scheduling application may access a connected server to determine whether the indicated invitees are available.

At processing block 130, a request for available resources (e.g., locations, inventory, etc.) at the specified time is received via the meeting scheduler UI. In some embodiments, the meeting schedule UI includes an interactive button or link to submit this request for available resources.

At processing block 140, the scheduling application determines the available resources by referencing a list (or catalog) of resources that is maintained by the scheduling application. The scheduling application then determines which resources on the list are available at the specified time. In some embodiments, the scheduling application will access a connected server to determine which resources on the list are available.

Embodiments of the invention may utilize various schemes to maintain the list (or catalog) of resources. In one embodiment, the scheduling application will track the most recent resources used by the scheduling application. Three scenarios for adding a resource to the list may be tracked: (1) adding recent resources that a user was invited to utilize; (2) adding recent resources that a user utilized in their own invitations; and (3) adding or updating resources that a user actually used, such as a location to attend a meeting or a piece of inventory used by the user.

In some embodiments, a pre-determined number of resources (e.g., 20 locations) may be maintained on the list at all times. In other embodiments, the resources may be tracked and established on the list according to their date/time stamp and the most recent usage policy. In some embodiments, resources may be removed from the list based on a first-in-first-out (FIFO) scheme. In yet other embodiments, those resources with the oldest date/time stamp may be removed when a new resource is to be added.

In other embodiments, the algorithm for maintaining the list of resources may be broader. The algorithm may encompass the ability of a user to specify resources to be permanently maintained on the list so that the resources will never fall off the list. For instance, those locations closest in proximity or in a particular locality to a user may be specified as permanent resources on the list. In addition, the list of resources may be provided to the user by an organization the user belongs to. The locations on the list are determined by the organization and may be based on settings such as proximity to user or resources in a particular area.

In some embodiments, the list may be maintained according to criteria other than recent usage by date and time. For instance, the list may be maintained by frequency of usage, or some combination thereof. One skilled in the art will appreciate that embodiments of the invention may encompass a user specializing the list according to their own particular circumstances.

Continuing with reference to FIG. 1, at processing block 150, the scheduling application provides to the user, via the meeting scheduling UI, the resources from the maintained list that are determined to be available at the specified time. Finally, at processing block 160, the scheduling application schedules one or more of the provided resources that were selected by the user. The scheduling application marks the resource(s) as occupied at the specified time without the user having to manually perform this action.

The maintained list described above allows a user of a scheduling application to select from a list of available resources without having to specify resources individually by memory. It also allows users to see all available resources on the list at one time, instead of determining one-by-one whether resources are available. In addition, the above-described process ensures that a user does not have to manually mark any resources as taken in order to reserve them and prevent other users from scheduling the locations.

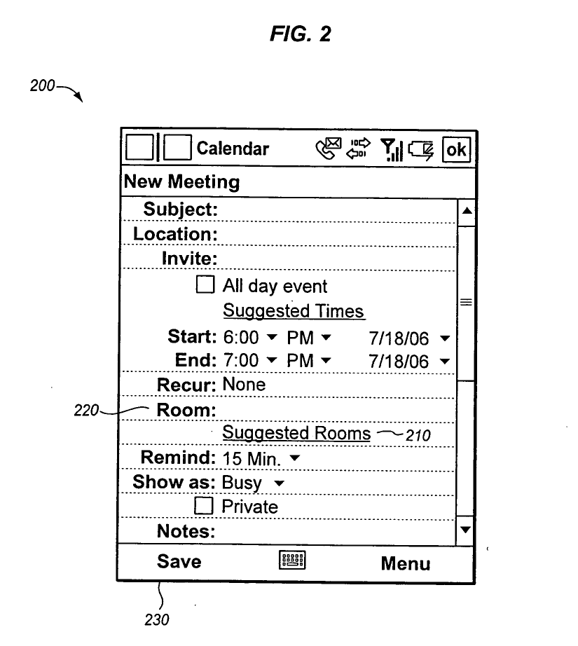

FIG. 2 is a screenshot depicting an embodiment of the calendar resource selection utility on a wireless messaging device. In this screenshot, a screen 200 for creating a new meeting is displayed. This meeting setup screen includes a “Suggested Rooms” link 210. A user can either enter a name of a resource (e.g., location) for the meeting or click on the Suggest Rooms link 210. The scheduling application will then determine, via a server or otherwise, which locations on a list of resources maintained by the scheduling application are available at the specified time.

As discussed above, in some embodiments, the list of resources may include the most recent locations that the user has been invited to, used in their own invitation, or has attended a meeting in. In other embodiments, the list of resources may also include the most recent inventory pieces (e.g., slide show projector, laptop, etc.) the user has utilized. The list may have a pre-determined number of entries in it at all times (e.g., 20). In addition, the list may be updated on a FIFO basis according to a date/time stamp, frequency of use, or other user-specified settings. In other embodiments, the list may include resources determined by the user that will remain on the list permanently. In some embodiments, the list may be pre-determined by an organization that the user belongs to. For instance, the list may be of all locations in a building of the user.

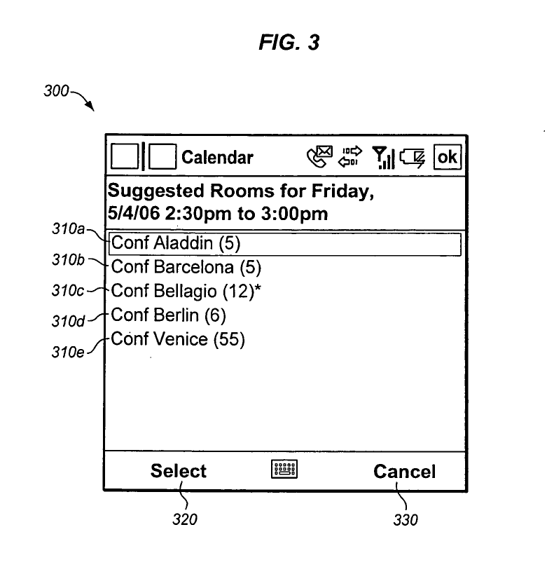

FIG. 3 is a screenshot depicting another embodiment of the calendar resource selection utility described herein. This screenshot 300 shows the results of selecting the “Suggested Rooms” link 210 from the screenshot of FIG. 2. This screenshot 300 shows the suggested rooms 310a-310e for the date and time specified for the meeting. In some embodiments, these rooms are returned from the server as the available locations from the list of resources maintained by the scheduling application. As these are only the locations that are available at the specified time, it should be anticipated that the entire list maintained by the server includes more locations than the number of locations returned as available.

As shown in FIG. 3, the name of the first location is “Conf Aladdin (5)” room 310a, followed by various other locations 310b-310e. The user can select the location or locations they prefer. The selection may be accomplished by highlighting the preferred location (or more than one location, if applicable) and then selecting the ‘select’ button 320. Note that if a user does not want to pick a location from the list in FIG. 3, they may also select the ‘cancel’ button 330 to return to the meeting setup screen 200 of FIG. 2.

Once one or more locations for the meeting have been selected, the user will be redirected to the meeting setup screen 200 from FIG. 2, which will have the selected location(s) displayed at the room entry 220. The user may then proceed to reserve the location(s) without having to manually mark the location(s) as a resource(s) by selecting the ‘save’ button 230. The scheduling application will automatically reserve the location(s) so that other users may not schedule the location(s) at the same date and time.

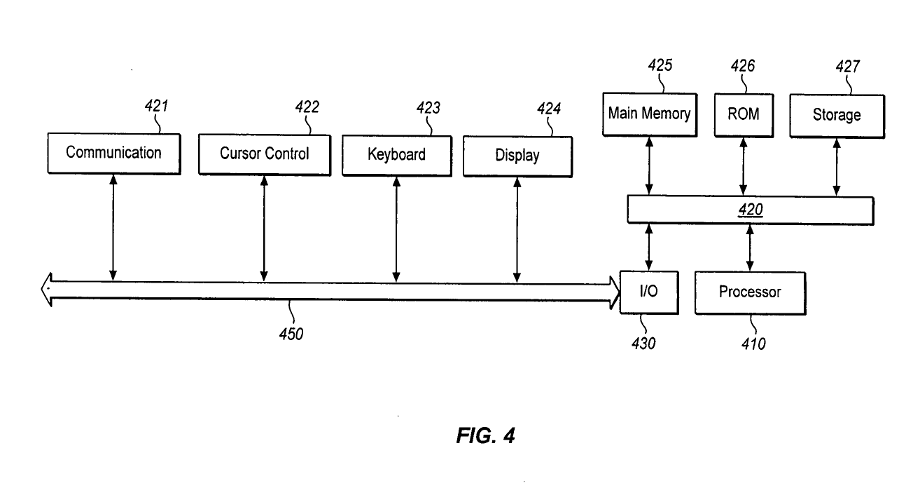

FIG. 4 illustrates a computer system 400 on which method 100 may be implemented. Computer system 400 includes a system bus 420 for communicating information, and a processor 410 coupled to bus 420 for processing information. One of ordinary skill in the art will appreciate that many types of processors may be used. According to some embodiments, computer system 400 may be located on a wireless device.

Computer system 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Computer system 400 also may include a read only memory (ROM) and/or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424; an input device (e.g., an alphanumeric input device 423 and/or a cursor control device 422).

The communication device 421 is for accessing other computers (servers or clients) via a network. The communication device 421 may comprise a modem, a network interface card, or other well-known interface device, such as those used for coupling to Ethernet, token ring, or other types of networks.

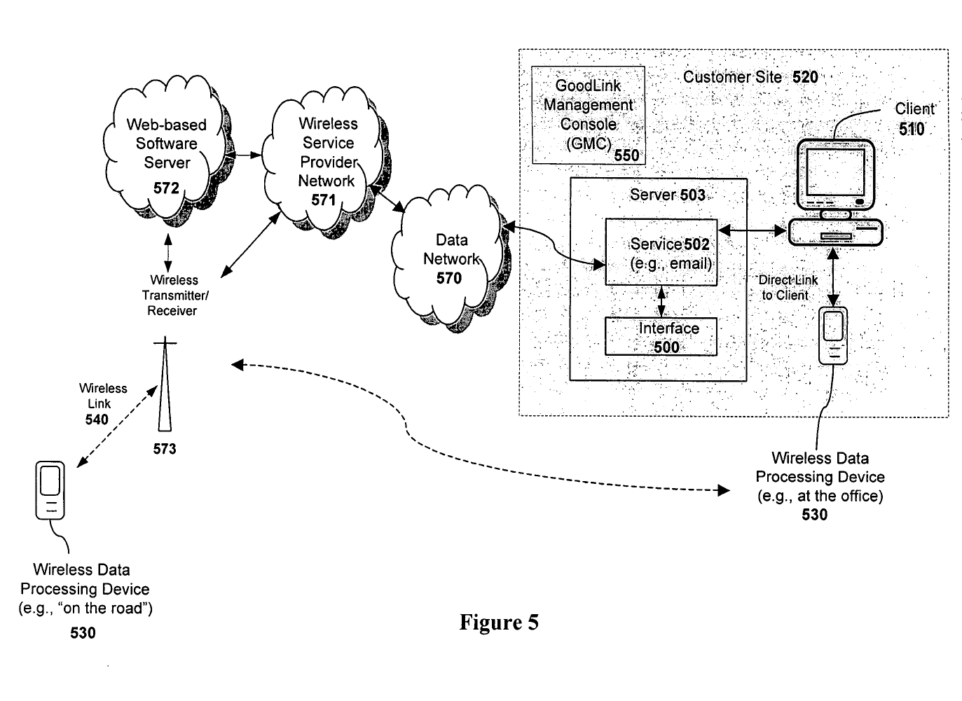

FIG. 5 illustrates one embodiment of a network architecture. It is envisioned that some embodiments of the invention, including the processes and components of FIGS. 1 through 4, may operate on wireless data processing device 530 of FIG. 5. A “customer site” 520 is illustrated in FIG. 5 and may be any local-area or wide-area network over which a plurality of servers 503 and clients 510 communicate. For example, customer site 520 may include all servers and clients maintained by a single corporation.

Servers 503 may provide a variety of different messaging and groupware services 502 to network users (e.g., e-mail, instant messaging, calendaring, etc). In one embodiment, these services are provided by Microsoft Exchange™. However, the underlying principles of the invention are not limited to any particular messaging/groupware platform.

In one embodiment, an interface 500 forwards data objects (e.g., e-mail messages, instant messages, calendar data, etc.) maintained by service 502 to a plurality of wireless data processing devices (represented in FIG. 5 by device 530) via an external data network 570 and/or a wireless service provider network 571. For example, if the service 502 includes an e-mail database, the interface 500 transmits any new e-mails, which arrive in a user's mailbox on the service 502 to the user's wireless data processing device 530 (over the network(s) 570 and/or 571).

Alternatively, or in addition, service 502 may provide the e-mail to the user's local computer (e.g., client 510) upon request (e.g., so that the user will receive the e-mail on his/her device 530 when out of the office and on his/her personal computer 510 when in the office). Conversely, e-mail messages transmitted from the user's wireless data processing device 530 are transmitted to the service 502 via the interface 500.

In one embodiment, interface 500 is a software module adapted to work with the particular service 502. It should be noted, however, that interface 500 may be implemented in hardware or any combination of hardware and software while still complying with the underlying principles of the invention.

In one embodiment, the external data network 570 includes a plurality of databases, servers/clients (not shown) and other networking hardware (e.g., routers, hubs, etc) for transmitting data between the interface 500 and the devices 530. In one embodiment, the interface 500 encapsulates data in one or more packets having an address identifying the devices 530 (e.g., such as a 24-bit Mobitex Access Number (“MAN #”).

The external data network 570 transmits the packets to a wireless service provider network 571, which in turn, transmits the packets (or the data contained therein) over wireless communication link 573 (e.g. cell tower) to the device 530. In one embodiment, the wireless service provider network is a CDMA 2000 network. However, various other network types may be employed (e.g., Mobitex, GPRS, PCS, etc.) while still complying with the underlying principles of the invention.

It should be noted that the network service provider network 571 and the external data network 570 (and associated interface 500) may be owned/operated by the same organization or, alternatively, the owner/operator of the external data network 570 may lease wireless services from the wireless service provider network. The underlying principles of the invention are not limited to any particular service arrangement.

In one embodiment, customer site 520 includes a management console (MC) 550. In a further embodiment, MC 550 is a GoodLink™ management console (GMC) developed by Good Technology®. Further wireless service provider network 571 is connected to a web-based software server 572. In one embodiment, web-based software server 572 is a web-store, which is used to distribute updates and applications to wireless devices (e.g. device 530).

According to one embodiment, updates and/or applications for device 530 are transmitted to web-based software server 572 from wireless service provider network 571, which are available for download by device 530. In one embodiment, the application to be downloaded is GoodLink™ client developed by Good Technology®. In another embodiment, notification of the availability of updates and/or applications is transmitted to customer site 520. At customer site 520, MC 550 allows an administrator to assign software policies for device 530. In one embodiment, the software policies determine which update and/or application notifications device 530 will receive.

Based on the software policies, customer site 520 then transmits a message to device 530 notifying device 530 of the updates and/or applications that are available to be downloaded from web-based software server 572.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

1. A method comprising:
at a wireless device with a scheduling application and a display:
maintaining a catalog of resources to be used for a meeting scheduled via a meeting setup interface of the scheduling application, the resources including locations for the meeting;
receiving, via the meeting setup interface, a request for locations for the meeting during a specified time of the meeting;
in response to receiving, via the meeting setup interface, the request for locations for the meeting during the specified time of the meeting:
referencing the catalog of resources to determine locations for the meeting;
wirelessly accessing a server to determine which of the locations for the meeting are available at the specified time of the meeting; and
displaying, on the display, locations for the meeting that are determined to be available at the specified time of the meeting;
while displaying, on the display, locations for the meeting that are determined to be available at the specified time of the meeting, receiving a selection of one of the locations for the meeting that are determined to be available at the specified time of the meeting;
scheduling the selected location for the meeting; and
marking the selected location for the meeting as occupied at the specified time of the meeting.

2. The method of claim 1 wherein the catalog of resources is maintained with a predetermined number of resources having the most recent date/time stamps.

3. The method of claim 2 wherein the date/time stamp for a resource is marked when the resource is at least one of: sent in a meeting request, received in a meeting request, or used during a meeting.

4. The method of claim 2 wherein a resource with the oldest date/time stamp is removed from the catalog when the catalog includes the maximum number of predetermined resources and a new resource is added to the catalog.

5. The method of claim 1 wherein the catalog of resources includes a predetermined number of resources provided by a user of the scheduling application that are permanently maintained on the catalog.

6. The method of claim 1 wherein the catalog of resources includes a list of resources provided to the scheduling application by an organization.

7. The method of claim 6 wherein the list of resources provided by the organization includes locations having a closest proximity to a user of the scheduling application.

8. The method of claim 1 wherein the catalog of resources is maintained with a predetermined number of resources having the most frequent usage by a user of the scheduling application.

9. A wireless device comprising:
a display;
one or more processors;
memory; and
one or more programs, including a scheduling application, wherein the one or more programs are stored in the memory and configured to be executed by the one or more processors, the one or more programs including instructions for:
maintaining a catalog of resources to be used for a meeting scheduled via a meeting setup interface of the scheduling application, the resources including locations for the meeting;
receiving, via the meeting setup interface, a request for locations for the meeting during a specified time of the meeting;
in response to receiving, via the meeting setup interface, the request for locations for the meeting during the specified time of the meeting:
referencing the catalog of resources to determine locations for the meeting;
wirelessly accessing a server to determine which of the locations for the meeting are available at the specified time of the meeting; and
displaying, on the display, locations for the meeting that are determined to be available at the specified time of the meeting;
while displaying, on the display, locations for the meeting that are determined to be available at the specified time of the meeting, receiving a selection of one of the locations for the meeting that are determined to be available at the specified time of the meeting;
scheduling the selected location for the meeting; and
marking the selected location for the meeting as occupied at the specified time of the meeting.

10. The wireless device of claim 9 wherein the catalog of resources is maintained with a predetermined number of resources having the most recent date/time stamps.

11. The wireless device of claim 9 wherein the catalog of resources includes a predetermined number of resources provided by a user of the scheduling application that are permanently maintained on the catalog.

12. The wireless device of claim 9 wherein the scheduling application accesses a server to schedule the one or more of the resources as occupied during the time of the meeting.

13. (canceled)

14. (canceled)

15. A non-transitory computer readable storage medium storing one or more programs, including a scheduling application, the one or more programs comprising instructions, which when executed by an wireless device with a display, cause the device to:
maintain a catalog of resources to be used for a meeting scheduled via a meeting setup interface of the scheduling application, the resources including locations for the meeting;
receive, via the meeting setup interface, a request for locations for the meeting during a specified time of the meeting;
in response to receiving, via the meeting setup interface, the request for locations for the meeting during the specified time of the meeting:
reference the catalog of resources to determine locations for the meeting;
wirelessly access a server to determine which of the locations for the meeting are available at the specified time of the meeting; and
display, on the display, locations for the meeting that are determined to be available at the specified time of the meeting;
while displaying, on the display, locations for the meeting that are determined to be available at the specified time of the meeting, receive a selection of one of the locations for the meeting that are determined to be available at the specified time of the meeting;
schedule the selected location for the meeting; and
mark the selected location for the meeting as occupied at the specified time of the meeting.

16. The non-transitory computer readable storage medium of claim 15 wherein the catalog of resources is maintained with a predetermined number of resources having the most recent date/time stamps.

17. The non-transitory computer readable storage medium of claim 16 wherein the date/time stamp for a resource is marked when the resource is at least one of: sent in a meeting request, received in a meeting request, or used during a meeting.

18. The non-transitory computer readable storage medium of claim 15 wherein the catalog of resources includes a predetermined number of resources provided by a user of the scheduling application that are permanently maintained on the catalog.

19. The non-transitory computer readable storage medium of claim 15 wherein the catalog of resources includes a list of resources provided to the scheduling application by an organization.

20. The non-transitory computer readable storage medium of claim 15 wherein the catalog of resources is maintained with a predetermined number of resources having the most frequent usage by a user of the scheduling application.
